(19) United States
(12) Patent Application Publication
(10) Pub. No.: US 2019/0210553 A1
(43) Pub. Date: Jul. 11, 2019

(54) AIRBAG

(71) Applicant: TOYOTA BOSHOKU KABUSHIKI KAISHA, Aichi (JP)

(72) Inventor: Takashi YOKOYAMA, Aichi-ken (JP)

(73) Assignee: TOYOTA BOSHOKU KABUSHIKI KAISHA, Aichi-ken (JP)

(21) Appl. No.: 16/242,690

(22) Filed: Jan. 8, 2019

(30) Foreign Application Priority Data
Jan. 9, 2018 (JP) 2018-001233

(51) Int. Cl. B60R 21/235; D03D 1/02; D03D 13/00; B60R 21/2338

(52) U.S. Cl. CPC B60R 21/235; D03D 1/02; D03D 13/00; B60R 2021/23509; D10B 2505/124; B60R 2021/23547; B60R 21/2338

(57) ABSTRACT

An airbag includes a bag and a tether. The bag includes a first woven fabric layer and a second woven fabric layer that are opposite each other and form a double woven fabric member produced with a one-piece weaving procedure. The tether includes a first tether thread and a first anchor thread. The first tether thread is one of the warp threads and the weft threads included in the first and second woven fabric layers and runs out from the second woven fabric layer and runs back again into the second woven fabric layer. The first anchor thread is another one of the warp threads and the weft threads included in the first and second woven fabric layers and the first tether thread is hooked on the first anchor thread so as to be pulled from two directions symmetrically by the first tether thread when the bag inflates.

### CROSS REFERENCE TO RELATED APPLICATION

This application claims priority from Japanese Patent Application No. 2018-001233 filed on Jan. 9, 2018. The entire contents of the priority application are incorporated herein by reference.

### TECHNICAL FIELD

The present disclosure relates to an airbag.

### BACKGROUND

An airbag has been widely known as a safety system for a vehicle such as an automobile. The airbag includes a bag that is folded into a small size. If an impact greater than a predetermined level acts on a vehicle from an outside, the bag inside the airbag inflates and protects an occupant from the impact. One type of such a bag is woven three-dimensionally with the one-piece weaving (OPW) procedure.

The bag is formed from two woven fabric layers and a tether is formed between the two woven fabric layers by weaving the warp threads into the two woven fabric layers alternately during the weaving. Thus, the tether is formed from a part of the warp threads. Each warp thread obliquely exits one of the two woven fabric layers and enters another one. The warp threads cross each other between the two opposing woven fabric layers.

If the bag having such a tether inflates, the warp thread exiting the woven fabric layer is pulled strongly and a weft thread that crosses the warp thread at basal end of the warp thread is also pulled strongly. Then, a distance between the weft thread that is pulled by the warp thread and another weft thread next to the weft thread is increased and a hole (displacement of a thread) may be formed. If such a hole is formed in the fabric, gas leaks from the bag through the hole to the outside and the inner pressure property of the bag may be deteriorated. The bag having such a tether is required to have a thick film laminated on a surface thereof and this may increase a cost.

### SUMMARY

An object of the present technology is to provide an airbag that is produced with a one-piece weaving procedure and causes less deformation of threads in a bag while using a part of warp threads and/or weft threads.

An airbag according to one aspect of a technology described herein includes a bag including a first woven fabric layer and a second woven fabric layer, and a tether connecting the first woven fabric layer and the second fabric layer. The first woven fabric layer and the second fabric layer are opposite each other and form a double woven fabric member produced with an one-piece weaving procedure, and the first woven fabric layer and the second woven fabric layer include warp threads and weft threads. The tether restricts a distance between the first woven fabric layer and the second woven fabric layer when the bag inflates. The tether includes a first tether thread that is one of the warp threads and the weft threads included in the first woven fabric layer and the second woven fabric layer and runs out from the second woven fabric layer and runs back again into the second woven fabric layer, and a first anchor thread that is another one of the warp threads and the weft threads included in the first woven fabric layer and on which the first tether thread is hooked so as to be pulled from two directions symmetrically by the first tether thread when the bag inflates.

An airbag according to another aspect of the technology described herein includes a bag including a first woven fabric layer and a second woven fabric layer and a tether connecting the first woven fabric layer and the second woven fabric layer. The first woven fabric layer and the second woven fabric layer are opposite each other and form a double woven fabric member produced with a one-piece weaving process and include warp threads and weft threads. The tether restricts a distance between the first woven fabric layer and the second woven fabric layer when the bag inflates. The tether includes a first anchor thread that is one of the warp threads and the weft threads included in the first woven fabric layer, a first tether thread that is another one of the warp threads and the weft thread included in the first woven fabric layer and the second woven fabric layer and runs into the first fabric layer at the first anchor thread, and a second tether thread that is the other one of the warp threads and the weft threads included in the first woven fabric layer and the second woven fabric layer and runs out from the first fabric layer at the first anchor thread. The first anchor thread is connected to the first tether thread and the second tether thread and is pulled from two directions symmetrically by the first tether thread and the second tether thread when the bag inflates.

### BRIEF DESCRIPTION OF THE DRAWINGS

FIG. 1 is a schematic view illustrating a cross-sectional configuration of an airbag according to a first embodiment.

FIG. 2 is a schematic view illustrating a woven texture of the airbag according to the first embodiment.

FIG. 3 is an enlarged cross-sectional view illustrating a part of a woven fabric layer including a tether thread hooked on an anchor thread.

FIG. 4 is a schematic view illustrating a cross-sectional configuration of an airbag of Comparative Example 1.

FIG. 5 is an enlarged cross-sectional view illustrating a part of a woven fabric layer including a tether thread hooked on a warp thread according to Comparative Example 1.

FIG. 6 is a schematic view illustrating a cross-sectional configuration of an airbag according to a second embodiment.

FIG. 7 is a schematic view illustrating a woven texture of the airbag according to the second embodiment.

FIG. 8 is a schematic view illustrating a cross-sectional configuration of an airbag according to a third embodiment.

FIG. 9 is a schematic view illustrating a woven texture of the airbag according to the third embodiment.

FIG. 10 is an enlarged cross-sectional view illustrating a part of a woven fabric layer including two kinds of tether threads hooked on an anchor thread.

FIG. 11 is a schematic view illustrating a cross-sectional configuration of an airbag according to a fourth embodiment.

FIG. 12 is a schematic view illustrating a woven texture of the airbag according to the fourth embodiment.

### DETAILED DESCRIPTION

### First Embodiment

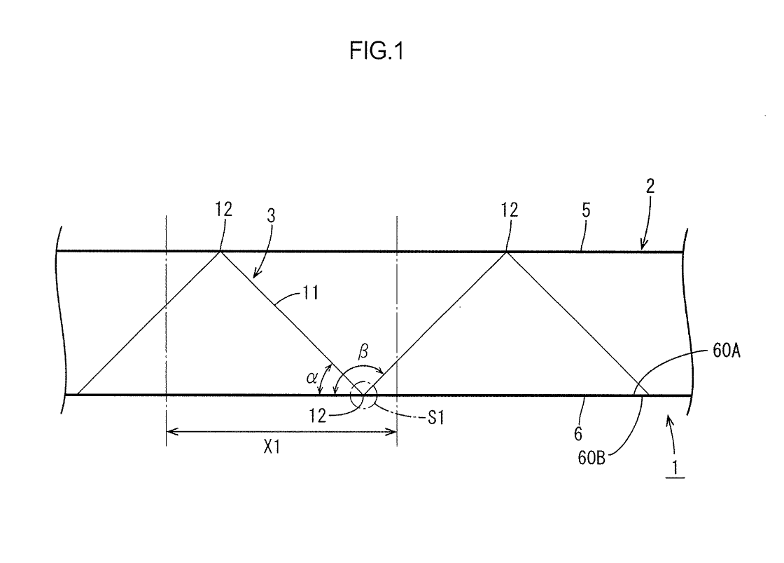

A first embodiment of the present technology will be described with reference to FIGS. 1 to 3. FIG. 1 illustrates an airbag 1 that inflates and the airbag 1 includes a bag 2 and a tether 3 included within the bag 2. The bag 2 and the tether 3 are included in a woven fabric member produced with the one-piece weaving (OPW) procedure.

The bag 2 includes two woven fabric layers 5, 6 that are opposed to each other and a peripheral edge portion (not illustrated) that surrounds the woven fabric layers 5, 6. In this specification, an upper side and a lower side in FIG. 1 correspond to a front side and a rear side of the airbag 1, respectively. The woven fabric layers 5, 6 form a double woven fabric member by weaving two fabric layers (woven fabric layers) at the same time with the OPW procedure. The peripheral edge portion of the bag 2 is a single fabric member formed from one fabric (a woven fabric) woven with the OPW procedure.

In this specification, a right-left direction is along a weft thread and a front-rear direction is along a warp thread in the drawings.

The tether 3 is formed from the warp threads and the weft threads of the two woven fabrics including a front woven fabric layer 5 and a rear woven fabric layer 6. Specifically, the tether 3 is formed from a weft thread of the front woven fabric layer 5 and the rear woven fabric layer 6 in this specification. The tether 3 includes a tether thread 11 and anchor threads 12. The tether thread 11 enters and exits the front woven fabric layer 5 and the rear woven fabric layer 6 alternately. Namely, the tether thread 11 is included in the front woven fabric layer 5 and the rear woven fabric later 6 as the weft thread thereof. The anchor threads 12 are warp threads of the front woven fabric layer 5 and the rear woven fabric layer 6 and the tether thread 11 is hooked on the anchor threads 12 such that woven fabric layer 5, 6 is pulled toward two directions symmetrically with respect to each anchor thread 12 by the tether thread 11. In FIG. 1, one tether thread 11 and three anchor threads 12 including two anchor threads 12 in the front woven fabric layer 5 and one anchor thread 12 in the rear woven fabric layer 6 are illustrated. The tether thread 11 is connected to each of the anchor threads 12 alternately in the front woven fabric layer 5 and the rear woven fabric layer 6.

The tether thread 11 runs along inner surfaces of the front and rear woven fabric layers 5, 6 from the left side toward the right side in FIG. 1. The tether thread 11 runs into the rear woven fabric layer 6 at an acute angle α through the inner surface 60A thereof and runs out from the rear woven fabric layer 6 at an obtuse angle β through the inner surface 60A thereof as illustrated in FIG. 1.

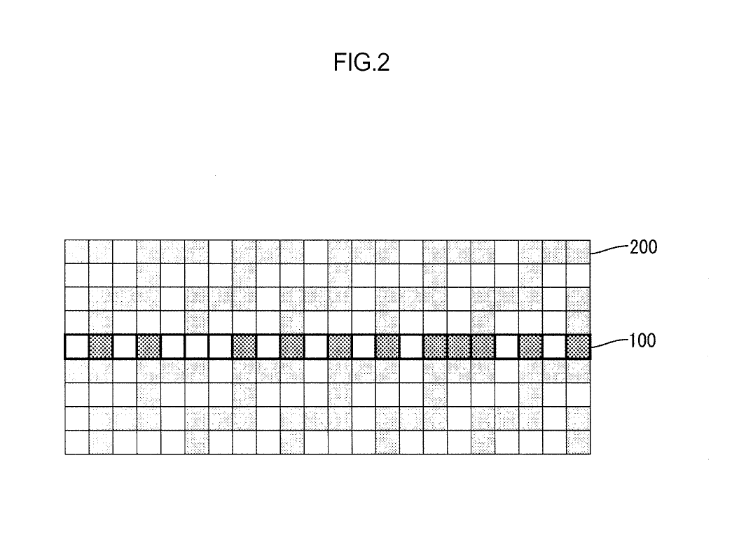

FIG. 2 illustrates a woven textile of a section X1 of the woven fabric layers in FIG. 1. In the woven textile of FIG. 2, a row direction (a right-left direction) is a weft direction and a column direction (a vertical direction) is a warp direction. The woven textile in FIG. 2 includes squares and the warp threads and the weft threads cross at each of the squares. Colored squares are parts of the warp threads that are disposed on a front side of the weft threads and non-colored squares are parts of the weft threads that are disposed on a front side of the warp threads. The colored squares and the non-colored squares in following embodiments have the same configurations as this embodiment.

FIG. 2 illustrates a double woven section 200 including the front woven fabric layer 5 and the rear woven fabric layer 6 of the bag 2. The double woven section 200 includes a woven section 100 in which the tether 3 including the tether thread 11 and the anchor threads 12 is formed.

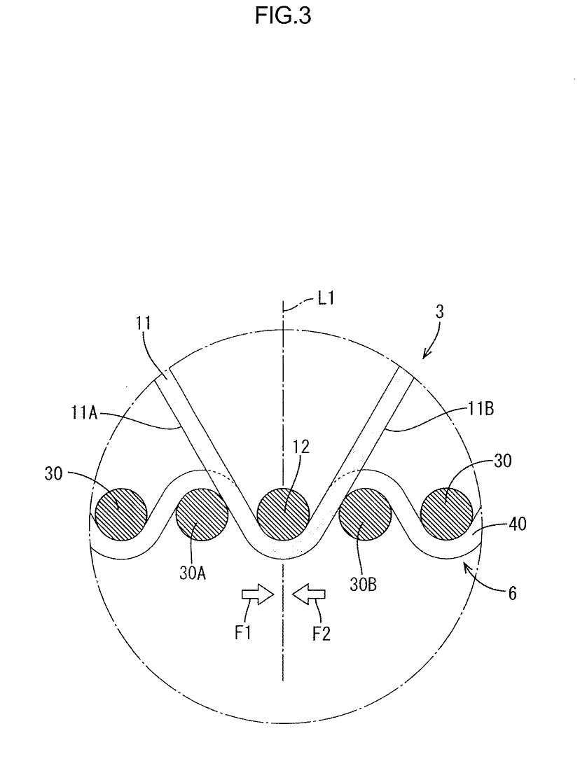

FIG. 3 illustrates a section S1 of the rear woven fabric layer 6 in FIG. 1. The section S1 includes warp threads 30 and weft threads 40 and one of the warp threads 30 of the rear woven fabric layer 6 is the anchor thread 12 and one of the weft threads 40 of the rear woven fabric layer 6 is the tether thread 11 in the section S1. A right side one and a left side one of the warp threads 30 next to the anchor thread 12 are a warp thread 30A and a warp thread 30B. The tether thread 11 is one of the weft threads 40 included in the rear woven fabric layer 6. The tether thread 11 hooked on the anchor thread 12 runs into the rear woven fabric layer 6 from the inner surface 60A through a space between the warp thread 30A and the anchor thread 12 and runs out from the space to an outer surface 60B side of the rear woven fabric layer 6. The tether thread 11 runs along the anchor thread 12 on the outer surface 60B side and runs back again to the inner surface 60A side of the rear woven fabric layer 6 through a space between the anchor thread 12 and the warp thread 30B.

As illustrated in FIG. 3, the tether thread 11 hooked on the anchor thread 12 includes a tether thread section 11A that runs into the rear woven fabric layer 6 from the inner surface 60A and a tether thread section 11B that runs out from the inner surface 60A of the rear woven fabric layer 6. When the bag 2 inflates, the tether thread 11 pulls the anchor thread 12 toward two directions symmetrically with respect to the anchor thread 12. Specifically, when the bag 2 inflates, the anchor thread 12 is pulled by the tether thread section 11A and the tether thread section 11B of the tether thread 11 from the two directions symmetrically with respect to an imaginary center line L1 that is vertical to the anchor thread 12.

As illustrated in FIG. 1, at the section S1, two end portions of the tether thread 11 with respect to the anchor thread 12 are connected to the front woven fabric layer 5 at the anchor threads 12. Therefore, when the bag 2 inflates, the anchor thread 12 is pulled by the two end portions of the tether thread 11 that are connected to the front woven fabric layer 5. Specifically, as illustrated in FIG. 3, if the bag 2 inflates, the anchor thread 12 is pulled by the tether thread section HA and the anchor thread 12 receives a force F1 so as to be away from the left warp thread 30A and the anchor thread 12 is also pulled by the tether thread section 11B and the anchor thread 12 receives a force F2 to be away from the right warp thread 30B. However, the force F1 and the force F2 are opposite from each other and they are cancelled each other. Therefore, a large gap (a hole) is less likely to be caused between the anchor thread 12 that is pulled by the tether thread 11 and the warp thread 30A or 30B next to the anchor thread 12.

In FIG. 3, the anchor thread 12 is pulled by the tether thread sections 11A and 11B of the tether thread 11 in an ideal way. It is effective that the anchor thread 12 is pulled by the tether thread sections 11A and 11B of the tether thread 11 from the two directions substantially symmetrically with respect to the anchor thread 12. In other sections near the anchor threads 12, a large gap or a hole that causes air leaking is less likely to be formed.

The airbag 1 of this embodiment includes a mounting section such as a hole (not illustrated) in which an inflator is inserted. The mounting section is included in a certain part of the bag 2.

### Comparative Example 1

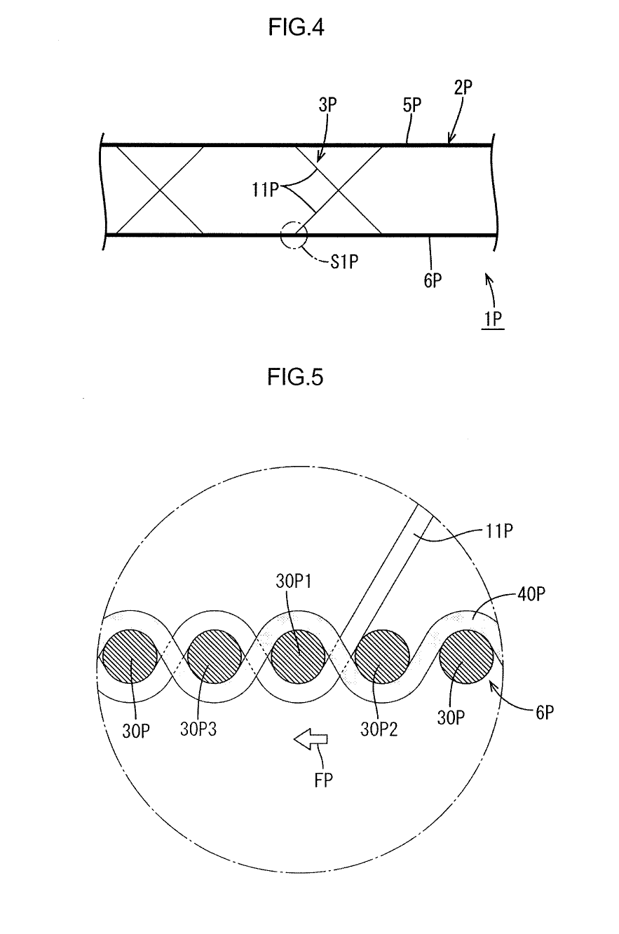

An airbag 1P of Comparative Example 1 will be described with reference to FIGS. 4 and 5. The airbag 1P is formed of a woven fabric member that is produced with the OPW procedure similar to the first embodiment. The airbag 1P includes a bag 2P and a tether 3P arranged within the bag 2P. The bag 2P includes a pair of woven fabric layers 5P, 6P that form a double woven member with the OPW procedure and a peripheral edge portion of the bag 2 that is a single fabric member surrounding the double woven member similarly to the first embodiment.

The tether 3P is formed from the warp threads and the weft threads of the front woven fabric layer 5P and the rear woven fabric layer 6P. Specifically, the tether 3 is formed from a weft thread included in the front woven fabric layer 5P and the rear woven fabric layer 6P. The tether 3P includes a tether thread 11P that runs out from the front woven fabric layer 5P and runs into the rear woven fabric layer 6P or a tether thread 11P that runs out from the rear woven fabric layer 6P and runs into the front woven fabric layer 5P.

FIG. 5 illustrates a section S1P of the rear woven fabric layer 6P in FIG. 4 and the section S1P includes warp threads 30P and weft threads 40P of the rear woven fabric layer 6P. As illustrated in FIG. 5, the tether thread 11P that runs obliquely upward from the rear woven fabric layer 6P toward the front woven fabric layer 5P is one of the weft threads 40P included in the rear woven fabric layer 6P. The tether thread 11P runs out from the rear woven fabric layer 6P through a gap between one 30P1 of the warp threads 30P of the rear woven fabric layer 6P and a warp thread 30P2 next to (right side) the warp thread 30P1. The tether thread 11P that runs out from the gap between the warp thread 30P1 and a left warp thread 30P3 does not run upward toward the front woven fabric layer 5P and is not connected to the front woven fabric layer 5P and woven into the rear woven fabric layer 6P as the weft thread 40P and crosses the warp threads 30P. Namely, the tether thread 11P runs out from the rear woven fabric layer 6P in only one direction with respect to the warp thread 30P1 and is connected to the front woven fabric layer 5P.

In such an airbag 1P of Comparative Example 1, if the bag 2 inflates, the warp thread 30P1 is pulled from only one direction by the tether thread 11P one end portion of which is connected to the front woven fabric layer 5P. Then, as illustrated in FIG. 5, the warp thread 30P1 on which the tether thread 11P is hooked receives a force FP to increase a gap between the warp thread 30P1 and the adjacent (right) warp thread 30P2. Therefore, a large hole is formed between the warp thread 30P1 on which the tether thread 11P is hooked and the adjacent warp thread 30P2. If the tether thread 11P is hooked on the warp thread 30P1 in only one direction, the warp thread 30P1 is displaced and a hole is formed in the rear woven fabric layer 6 and air leaks therefrom. To prevent the leaking of air, a resin thick film such as a silicone film or a thick lamination layer may be necessary to be formed on the surface of the bag 2P (surfaces of the woven fabric layers 5P, 6P) to keep airtight properties of the airbag.

### Second Embodiment

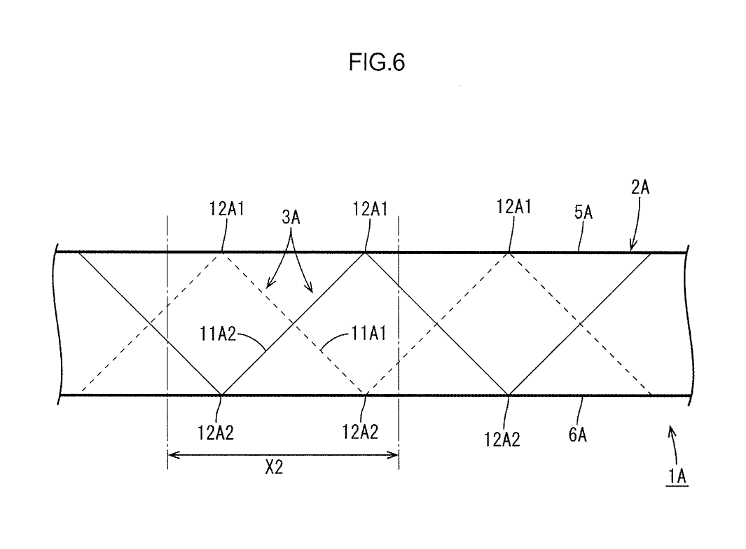

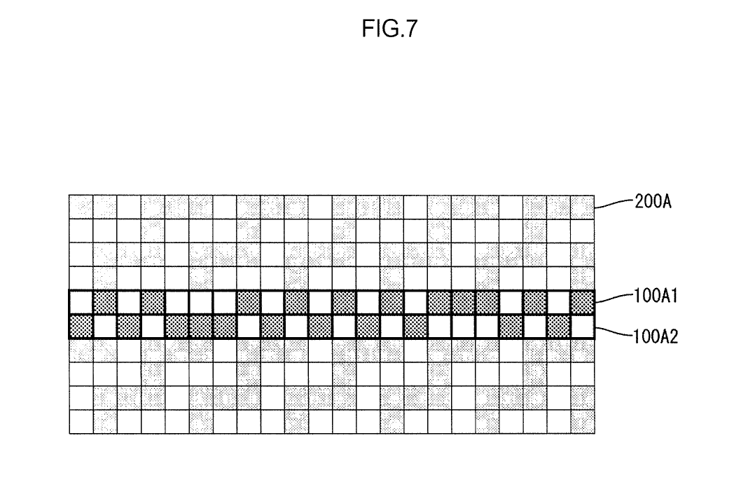

Next, an airbag 1A according to a second embodiment will be described with reference to FIGS. 6 and 7. The airbag 1A has a basic configuration same as that of the first embodiment and includes a bag 2A made of a woven fabric with the OPW procedure and a tether 3A included in the bag 2A and produced with the OPW procedure. Unlike the first embodiment, the tether 3A of this embodiment includes two tether threads 11A1, 11A2 that enter and exit the different sections of the woven fabric layers.

In FIG. 6, a first tether thread 11A 1 is illustrated with a dotted line and is a weft thread and runs into and out from the front woven fabric layer 5A and the rear woven fabric layer 6A alternately. The first tether thread 11A1 is hooked on first anchor threads 12A1 in the front woven fabric layer 5A and second anchor threads 12A2 in the rear woven fabric layer 6A alternately.

In addition to the first tether thread 11A 1, this embodiment further includes a second tether thread 11A2. The second tether thread 11A2 is a weft thread and runs into and out from the front woven fabric layer 5A and the rear woven fabric layer 6A alternately. The first tether thread 11A1 is hooked on the first anchor threads 12A1 in the front woven fabric layer 5A and the second thread anchor threads 12A2 in the rear woven fabric layer 6A alternately. Namely, the first anchor threads 12A1 are warp threads of the front woven fabric layer 5A and the second anchor threads 12A2 are warp threads of the rear woven fabric layer 6A. As illustrated in FIG. 6, the first tether thread 11A 1 and the second tether thread 11A2 cross each other in a space between the front woven fabric layer 5A and the rear woven fabric layer 6A. As illustrated in FIG. 6, the first anchor threads 12A1 and the second anchor threads 12A2 are opposite each other The first anchor thread 12A1 on which the first tether thread 11A1 is hooked and the second anchor thread 12A2 on which the second tether thread 11A2 is hooked are warp threads that are arranged opposite each other.

FIG. 7 illustrates a woven textile of a section X2 in FIG. 6. FIG. 7 illustrates a double woven section 200A including the front woven fabric layer 5A and the rear woven fabric layer 6A of the bag 2A. The double woven section 200A includes a woven section 100A1 for the first tether thread 11A 1 and a woven section 100A2 for the second tether thread 11A2. The first tether thread 11A1 and the second tether thread 11A2 are next to each other.

The tether may include various types of tether threads that run into and out from different sections. In the present embodiment, a large gap (a hole) that may cause air leaking is less likely to be formed in the sections near the anchor threads 12A1, 12A2 similar to the first embodiment.

### Third Embodiment

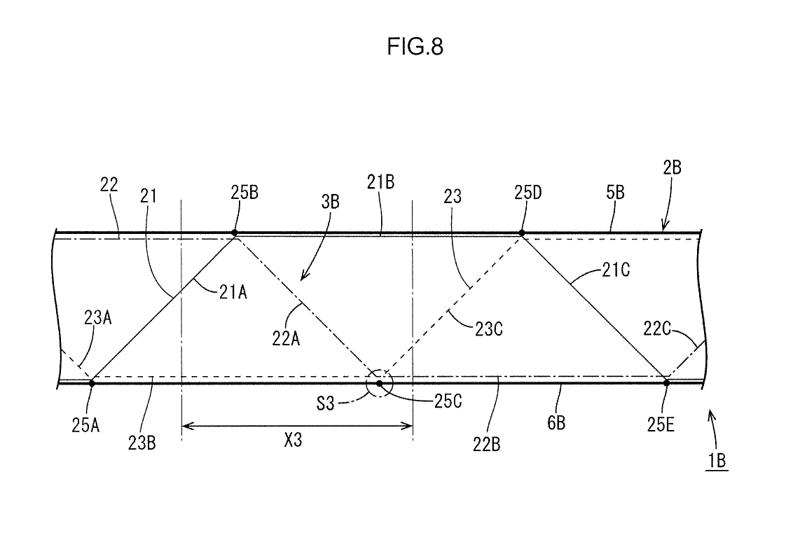

Next, an airbag 1B according to a third embodiment will be described with reference to FIGS. 8 to 10. The airbag 1B includes a bag 2B made of a woven fabric with the OPW procedure and a tether 3B included in the bag 2B and produced with the OPW procedure similar to the first embodiment. Unlike the first and second embodiments, in this embodiment, one anchor thread is pulled by two tether threads in two directions symmetrically.

As illustrated in FIG. 8, the tether 3B of this embodiment includes a first tether thread 21 illustrated with a solid line, a second tether thread 22 illustrated with a dashed line, and a third tether thread 23 illustrated with a dotted line.

The first tether thread 21 is formed from a weft thread included in the front woven fabric layer 5B and the rear woven fabric layer 6B. The first tether thread 21 includes a tether thread section 21A that runs out from the rear woven fabric layer 6B at an anchor thread 25A and runs into the front woven fabric layer 5B at an anchor thread 25B and a tether thread section 21B that runs along the front woven fabric layer 5B and a tether thread section 21C that runs out from the front woven fabric layer 5B at an anchor thread 25D and runs into the rear woven fabric layer 6B at an anchor thread 25E.

The second tether thread 22 is formed from a weft thread included in the front woven fabric layer 5B and the rear woven fabric layer 6B. The second tether thread 22 includes a tether thread section 22A that runs out from the front woven fabric layer 5B at the anchor thread 25B and runs into the rear woven fabric layer 6B at the anchor thread 25C and a tether thread section 22B that runs along the rear woven fabric layer 6B and a tether thread section 22C that runs out from the rear woven fabric layer 6B toward the front woven fabric layer 5B.

The third tether thread 23 is formed from a weft thread included in the front woven fabric layer 5B and the rear woven fabric layer 6B. The third tether thread 23 includes a tether thread section 23A that runs out from the front woven fabric layer 5B and runs into the rear woven fabric layer 6B at the anchor thread 25A and a tether thread section 23B that runs along the rear woven fabric layer 6B and a tether thread section 23C that runs out from the rear woven fabric layer 6B at the anchor thread 25C and runs into the front woven fabric layer 5B at the anchor thread 25D.

The anchor threads 25A to 25E are warp threads included in the front woven fabric layer 5B and the rear woven fabric layer 6B. Each of the anchor threads 25A to 25E is pulled by two adjacent ones of the three tether threads 21, 22, 23 in two directions symmetrically. The two adjacent ones of the tether threads 21, 22, 23 are adjacent to each other and are hooked on the same anchor thread. For simple description, the three tether threads 21, 22, 23 are illustrated away from the woven fabric layers 5B, 6B in FIG. 8.

The first anchor thread 25A at the left end in FIG. 8 is connected to the third tether thread 23 and the first tether thread 21. Specifically, the tether thread section 23A of the third tether thread 23 running into the rear woven fabric layer 6B through the inner surface thereof and the tether thread section 21A of the first tether thread 21 running out from the rear woven fabric layer 6B through the inner surface thereof are hooked on (connected to) the first anchor thread 25A included in the rear woven fabric layer 6B.

The second anchor thread 25B at a second one from the left in FIG. 8 is connected to the first tether thread 21 and the second tether thread 22. Specifically, the tether thread section 21A of the first tether thread 21 running into the front woven fabric layer 5B through the inner surface thereof and the tether thread section 22A of the second tether thread 22 running out from the front woven fabric layer 5B through the inner surface thereof are hooked on (connected to) the second anchor thread 25B included in the front woven fabric layer 5B.

The third anchor thread 25C at a third one from the left in FIG. 8 is connected to the second tether thread 22 and the third tether thread 23. Specifically, the tether thread section 22A of the second tether thread 22 running into the rear woven fabric layer 6B through the inner surface thereof and the tether thread section 23C of the third tether thread 23 running out from the rear woven fabric layer 6B through the inner surface thereof are hooked on (connected to) the third anchor thread 25C included in the rear woven fabric layer 6B.

The fourth anchor thread 25D at a fourth one from the left in FIG. 8 is connected to the third tether thread 23 and the first tether thread 21. Specifically, the tether thread section 23C of the third tether thread 23 running into the front woven fabric layer 5B through the inner surface thereof and the tether thread section 21C of the first tether thread 21 running out from the front woven fabric layer 5B through the inner surface thereof are hooked on (connected to) the fourth anchor thread 25D included in the front woven fabric layer 5B.

The fifth anchor thread 25E at right end side in FIG. 8 is connected to the first tether thread 21 and the second tether thread 22. Specifically, the tether thread section 21C of the first tether thread 21 running into the rear woven fabric layer 6B through the inner surface thereof and the tether thread section 22C of the second tether thread 22 running out from the rear woven fabric layer 6B through the inner surface thereof are hooked on (connected to) the fifth anchor thread 25E included in the rear woven fabric layer 6B.

Thus, two of the tether threads are hooked on the same anchor thread and each of the anchor threads is pulled by two tether threads that are connected to the anchor thread.

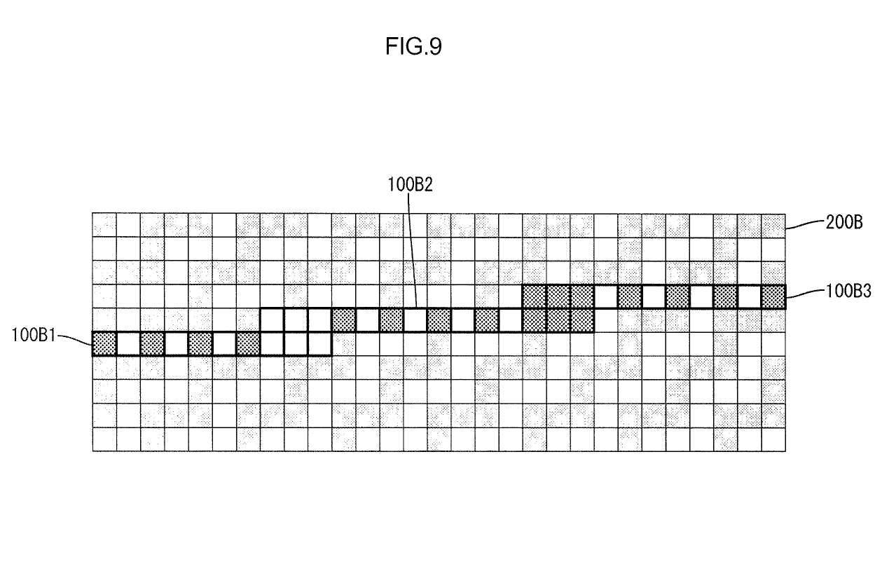

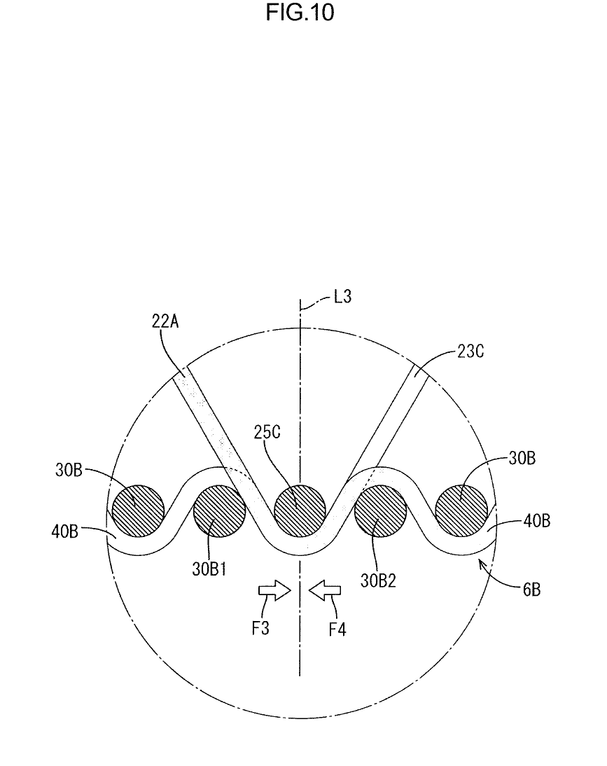

FIG. 9 illustrates a woven textile of a section X3 in FIG. 8. FIG. 9 illustrates a double woven section 200B including the front woven fabric layer 5B and the rear woven fabric layer 6B of the bag 2B. The double woven section 200B includes a woven section 100B1 for the first tether thread 21 of the tether 3B, a woven section 100B2 for the second tether thread 22, and a woven section 100B3 for the third tether thread 23.

FIG. 10 is an enlarged cross-sectional view of a section S3 near the third anchor thread 25C of the airbag 1B of the third embodiment in FIG. 8. In the section S3, two of the tether threads that are, the second tether thread 22 and the third tether thread 23 are hooked on the third anchor thread 25C. The warp threads 30B and the weft thread 40B of the rear woven fabric layer 6B are illustrated in FIG. 10. The third anchor thread 25C is one of the warp threads 30B included in the rear woven fabric layer 6B and a warp thread 30B1 is on the left side of the third anchor thread 25C and a warp thread 30B2 is on the right side thereof. The second tether thread 22 that is hooked on the third anchor thread 25C is one of the weft threads 40 and the third tether thread 23 that is hooked on the third anchor thread 25C is another one of the weft threads 40B. The second tether thread 22 and the third tether thread 23 are the weft threads 40B that are next to each other.

As illustrated in FIG. 10, the second tether thread 22 that is hooked on the third anchor thread 25C runs into a gap between the third anchor thread 25C and the warp thread 30B1 from the inner surface of the rear woven fabric layer 6B and runs out from the outer surface of the rear woven fabric layer 6B and runs along the outer side of the third anchor thread 25C. The second tether thread 22 further runs into a gap between the third anchor thread 25C and the warp thread 30B2 from the outer surface of the rear woven fabric layer 6B and runs out of the gap and repeatedly runs into and out from subsequent gaps to be woven with the warps 30B and merged into the rear woven fabric layer 6B.

The third tether thread 23 and the second tether thread 22 are symmetrical with respect to the third anchor thread 25C. The third tether thread 23 runs into a gap between the third anchor thread 25C and the warp thread 30B2 form the inner surface of the rear woven fabric layer 6B in an opposite side from the second tether thread 22, and runs out from the outer surface of the rear woven fabric layer 6B and runs along the outer side of the third anchor thread 25C. The third tether thread 23 further runs into a gap between the third anchor thread 25C and the warp thread 30B1 from the outer surface of the rear woven fabric layer 6B and runs out of the gap and repeatedly runs into and out from subsequent gaps to be woven with the warps 30B and merged into the rear woven fabric layer 6B.

Thus, two of the tether threads that are the second tether thread 22 and the third tether thread 23 are hooked on the third anchor thread 25C. According to such a configuration, if the bag 2B inflates, the third anchor thread 25C is pulled from two directions symmetrically by the two tether threads of the second tether thread 22 and the third tether thread 23. Specifically, the third anchor thread 25C is pulled by the tether thread section 22A of the second tether thread 22 illustrated on the left side in FIG. 10 and the tether thread section 23C of the third tether thread 23 illustrated on the right side in FIG. 10. Accordingly, the third anchor thread 25C is pulled from the two directions symmetrically with respect to an imaginary center line L3 vertical to the third anchor thread 25C.

As illustrated in FIG. 10, if the bag 2B inflates, the third anchor thread 25C is pulled by the tether thread section 22A of the second tether thread 22 and receives a force F3 so as to be away from the left warp thread 30B1. Furthermore, if the bag 2B inflates, the third anchor thread 25C is pulled by the tether thread section 23C of the third tether thread 23 and receives a force F4 so as to be away from the right warp thread 30B2. Namely, if the bag 2B inflates, the third anchor thread 25C receives the force F3 and the force F4. The force F3 and the force F4 are opposite from each other and they are cancelled each other. Therefore, a large gap (a hole) that may cause air leaking is less likely to be caused between the third anchor thread 25C that is pulled by the second tether thread 22 and the third tether thread 23 and each of the warp thread 30B1 or 30B2 next to the third anchor thread 25C.

In FIG. 10, the third anchor thread 25C is pulled by the second tether thread 22 and the third tether thread 23 in an ideal way. It is effective that the third anchor thread 25C is pulled by the second tether thread 22 and the third tether thread 23 from the two directions substantially symmetrically with respect to the third anchor thread 25C. In other sections near the anchor threads, a large gap or a hole that causes air leaking is less likely to be formed.

According to this embodiment, one anchor thread is pulled by the two (a pair of) tether threads. According to such a configuration, if a part of the tether 3B (the tether thread) is cut or torn during inflation of the bag 2B, the cut tether thread is less likely to be loosened from the woven fabric layers 5B, 6B. According to the airbag 1B of this embodiment, the tether 3B can keep its function as a whole even if a part of the tether thread is cut.

### Fourth Embodiment

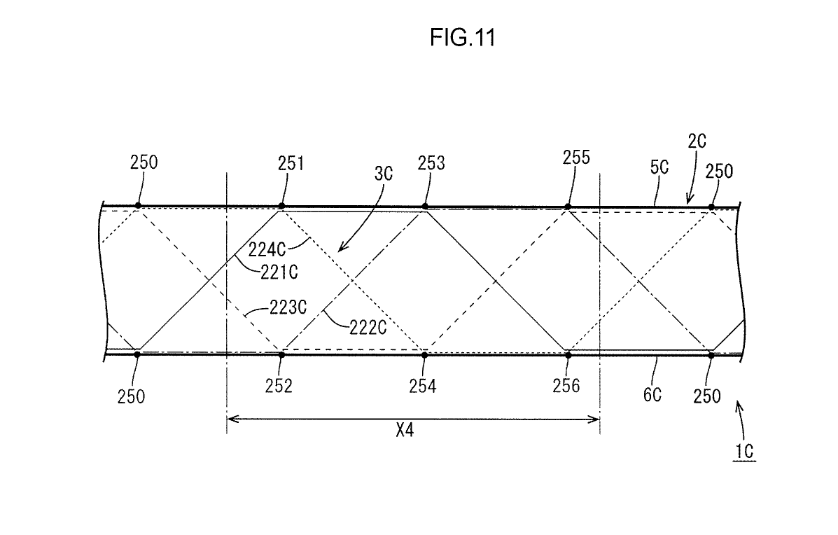

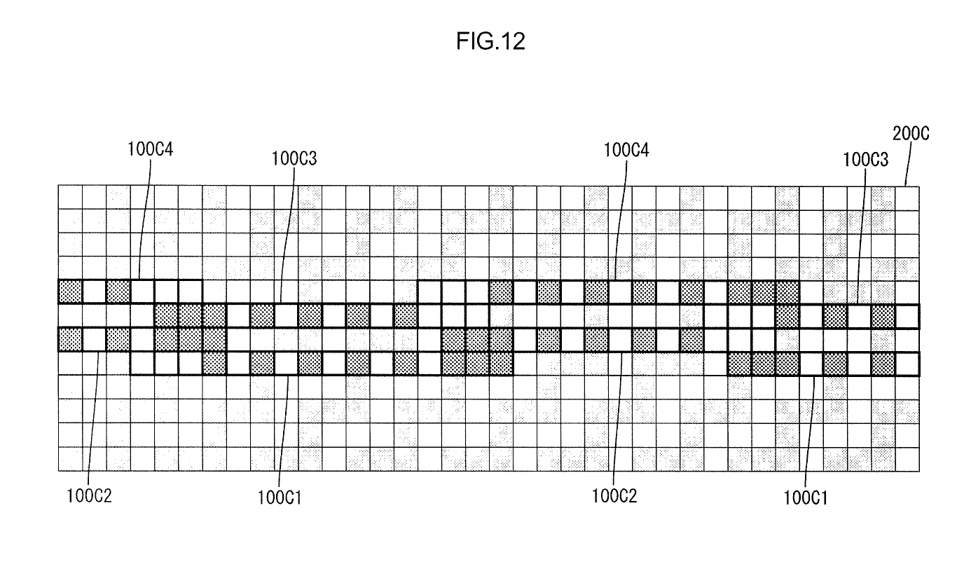

Next, an airbag 1C according to a fourth embodiment will be described with reference to FIGS. 11 and 12. The airbag 1C includes a bag 2C made of a fabric woven with the OPW procedure and a tether 3C included in the bag 2C and produced with the OPW procedure similar to the first embodiment. Similar to the third embodiment, the tether 3C of this embodiment is pulled from two directions symmetrically by two (a pair of) tether threads Unlike the first and second embodiments, the tether 3B of this embodiment is configured such that one anchor thread 250 is pulled by two tether threads in two directions symmetrically. As illustrated in FIG. 11, the tether 3C of this embodiment includes four tether threads 21C, 22C, 23C, 24C.

Each of the tether threads 21C, 22C, 23C, 24C is a weft thread included in woven fabric layers 5C, 6C. Each of the tether threads includes a section running out from the front woven fabric layer 5C and running into the rear woven fabric layer 6C and a section running out from the rear woven fabric layer 6C and running into the front woven fabric layer 5C. The tether threads of this embodiment include a first tether thread 221C, a second tether thread 222C, a third tether thread 223C, and a fourth tether thread 224C that are arranged in this order within the woven fabric layers 5C and 6C.

The anchor thread 250 is one of the warp threads in the front woven fabric layer 5C or one of the warp threads in the rear woven fabric layer 6C. The anchor thread 250 is pulled by two of the four kinds of tether threads 221C, 222C, 223C, and 224C from two directions symmetrically.

FIG. 12 illustrates a woven textile of a section X4 of the airbag 1C in FIG. 11. FIG. 12 illustrates a double woven section 200C including the front woven fabric layer 5C and the rear woven fabric layer 6C of the bag 2C. The double woven section 200C includes a woven section 100C1 for the first tether thread 221C of the tether 3C, a woven section 100C2 for the second tether thread 222C, a woven section 100C3 for the third tether thread 223C, and a woven section 100C4 for the fourth tether thread 224C.

The first tether thread 221C and the fourth tether thread 224C are hooked on the first anchor thread 251 that is one of the anchor threads on the left side in the section X4 in FIG. 11 and is included in the front woven fabric layer 5C. Namely, the first tether thread 221C makes a pair with the fourth tether thread 224C and the first tether thread 221C and the fourth tether thread 224C are arranged while having two tether threads 222C, 223C therebetween. The pair of tether threads 221C and 224C are hooked on the first anchor thread 251. The two tether threads 222C and 223C that are adjacent to each other are hooked on the anchor thread 252 that is included in the rear woven fabric layer 6C.

In the section X4 in FIG. 11, the two adjacent tether threads of the first tether thread 221C and the second tether thread 222C are hooked on the front anchor thread 253 that is arranged in a middle of the section X4. The two adjacent tether threads of the third tether thread 223C and the fourth tether thread 224C are hooked on the rear anchor thread 254.

The two adjacent tether threads of the second tether thread 222C and the third tether thread 223C are hooked on the front anchor thread 255 that is one of the two anchor threads on the right side in the section X4 in FIG. 11. The first tether thread 221C and the fourth tether thread 224C are hooked on the rear anchor thread 255.

Similar to the third embodiment, according to the airbag 1C of this embodiment, the tether 3C can keep its function as a whole even if a part of the tether thread is cut.

### Other Embodiments

The technology described herein is not limited to the embodiments described above with reference to the drawings. The following embodiments may be included in the technical scope.

(1) The airbag of the technology described herein can be used as a vehicular airbag such as a curtain airbag, a side airbag, a knee airbag, a driver's seat airbag, a passenger's seat airbag, a ITS head airbag, and a pedestrian protective airbag. The airbag of the technology described herein may be used as an airbag for devices other than vehicles.

(2) The configuration of the warp threads and the weft threads may be altered from that in the above embodiments. For example, the warp threads may be used as the tether thread and the weft threads may be used as the anchor threads.

(3) The tether threads may be arranged in a direction parallel to the warp threads.

(4) A bundle of the weft threads or the warp threads may be used as one anchor thread.

(5) One tether thread or two tether threads may be hooked on only one anchor thread.

(6) A film lamination may be provided on a surface of the airbag instead of the resin film.

1. An airbag comprising:
a bag including a first woven fabric layer and a second woven fabric layer that are opposite each other and form a double woven fabric member produced with an one-piece weaving procedure, the first woven fabric layer and the second woven fabric layer including warp threads and weft threads; and
a tether connecting the first woven fabric layer and the second woven fabric layer and restricting a distance between the first woven fabric layer and the second woven fabric layer when the bag inflates, the tether including
a first tether thread that is one of the warp threads and the weft threads included in the first woven fabric layer and the second woven fabric layer and runs out from the second woven fabric layer and runs back again into the second woven fabric layer, and
a first anchor thread that is another one of the warp threads and the weft threads included in the first woven fabric layer and on which the first tether thread is hooked so as to be pulled from two directions symmetrically by the first tether thread when the bag inflates.

2. The airbag according to claim 1, wherein
the tether further includes a second anchor thread included in the second woven fabric layer,
the first tether thread runs into and out from the first woven fabric layer at the first anchor thread and runs into and out from the second woven fabric layer at the second anchor thread, and
the first tether thread is hooked on the first anchor thread and the second anchor thread such that the first anchor thread is pulled by the first tether thread from two directions symmetrically with respect to the first anchor thread and the second anchor thread is pulled by the first tether thread from two directions symmetrically with respect to the second anchor thread, when the bag inflates.

3. The airbag according to claim 1, wherein the first tether thread has two end portions with respect to a hooked portion thereof that is hooked on the first anchor thread and the two end portions are connected to the second woven fabric layer.

4. The airbag according to claim 3, wherein
the tether further includes second anchor threads included in the second woven fabric layer, and
the two end portions of the first tether thread are connected to the second anchor threads.

5. The airbag according to claim 3, wherein
the tether further includes a second tether thread and a second anchor thread that is included in the second woven fabric layer,
the second tether thread is next to the first tether thread,
the first anchor thread is opposite the second anchor thread, and
the second tether thread has a hooked portion that is hooked on the second anchor thread and has two end portions with respect to the hooked portion thereof and the two end portions of the second tether thread is connected to the first woven fabric layer.

6. The airbag according to claim 1, wherein
the tether further includes second anchor threads in the second woven fabric layer and the first anchor thread includes first anchor threads in the first woven fabric layer, and
the first tether thread runs through the first woven fabric layer and the second woven fabric layer alternately while being connected to each of the first anchor threads in the first woven fabric layer and each of the second anchor threads in the second woven fabric layer alternately.

7. The airbag according to claim 6, wherein
the tether further includes a second tether thread that is next to the first tether thread,
the first anchor threads are opposite the second anchor threads, respectively,
the second tether thread runs through the first woven fabric layer and the second woven fabric layer alternately while being connected to each of the first anchor threads in the first woven fabric layer and each of the second anchor threads in the second woven fabric layer alternately, and
the first tether thread and the second tether thread cross each other in a space between the first woven fabric layer and the second woven fabric layer.

8. An airbag comprising:
a bag including a first woven fabric layer and a second woven fabric layer that are opposite each other and form a double woven fabric member produced with an one-piece weaving process, the first woven fabric layer and the second woven fabric layer including warp threads and weft threads; and
a tether connecting the first woven fabric layer and the second woven fabric layer and restricting a distance between the first woven fabric layer and the second woven fabric layer when the bag inflates, the tether including
a first anchor thread that is one of the warp threads and the weft threads included in the first woven fabric layer,
a first tether thread that is another one of the warp threads and the weft thread included in the first woven fabric layer and the second woven fabric layer and runs into the first fabric layer at the first anchor thread, and
a second tether thread that is the other one of the warp threads and the weft threads included in the first woven fabric layer and the second woven fabric layer and runs out from the first fabric layer at the first anchor thread, wherein
the first anchor thread is connected to the first tether thread and the second tether thread and is pulled from two directions symmetrically by the first tether thread and the second tether thread when the bag inflates.

9. The airbag according to claim 8, wherein the first tether thread is next to the second tether thread.

10. The airbag according to claim 9, wherein
the tether further includes second anchor threads in the second woven fabric layer and the first anchor thread includes first anchor threads in the first woven fabric layer,
the first anchor threads include a former first anchor thread and a latter first anchor thread and the second anchor threads include a former second anchor thread and a latter second anchor thread,
the former second anchor thread is between the former first anchor thread and the latter first anchor thread and the latter first anchor thread is between the former second anchor thread and the latter second anchor thread,
the first tether thread runs into the first woven fabric layer at the latter first anchor thread and the second tether thread runs out from the first woven fabric layer at the latter first anchor thread, and
the latter first anchor thread is pulled from two directions symmetrically by the first tether thread and the second tether thread when the bag inflates.

11. The airbag according to claim 10, wherein
the first tether thread runs along the second woven fabric layer and runs out from the second woven fabric layer at the former second anchor thread and runs into the first woven fabric layer at the latter first anchor thread and runs along the first woven fabric layer, and
the second tether thread runs along the first woven fabric layer and runs out from the first woven fabric layer at the latter first anchor thread and runs into the second woven fabric layer at the latter second anchor thread and runs along the second woven fabric layer.
